(19) United States
(12) Patent Application Publication
(10) Pub. No.: US 2006/0050456 A1
(43) Pub. Date: Mar. 9, 2006

(54) Semiconductor integrated circuit and video signal amplification method

(75) Inventors: Toshinobu Nagasawa, Osaka-shi (JP); Tetsushi Toyooka, Muko-shi (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Kadoma-shi (JP)

(21) Appl. No.: 11/220,062

(22) Filed: Sep. 6, 2005

(30) Foreign Application Priority Data
Sep. 7, 2004 (JP) JP2004-259250

(51) Int. Cl. H02H 9/00

(52) U.S. Cl. 361/56

(57) ABSTRACT

A semiconductor integrated circuit includes: a charge pumping circuit for generating a negative power supply voltage; an input portion for biasing an average value of an input signal at 0V; and a video signal output portion that operates with a positive/negative power supply utilizing the charge pumping circuit as a negative power supply to amplify the zero-biased signal, outputting signals of positive/negative polarity. A diode clamp circuit is connected to the input portion, and a maximum level of a voltage of the input signal on the negative side is clamped to a clamp voltage produced by the diode clamp circuit when the maximum level of the voltage of the input signal on the negative side is lower than the clamp voltage, thereby suppressing shrinkage of the output signal on the negative side. SYNC shrinkage in the video signal output portion during high luminance signal input is suppressed.

### BACKGROUND OF THE INVENTION

1. Field of the Invention

The present invention relates to a semiconductor integrated circuit with a video output circuit capable of outputting signals with positive and negative polarity using a negative power supply generated by a charge pumping circuit, and, in particular, to a configuration used for preventing signal shrinkage on the negative side.

2. Description of Related Art

Semiconductor integrated circuits that have positive and negative power supplies and drive loads at an average level of 0 volts have been known in the past among semiconductor integrated circuits that output analog video signals. With respect to such semiconductor integrated circuits, JP H7-106963A describes an integrated circuit that includes a circuit generating a negative power supply from a single positive power supply voltage and is capable of outputting signals with positive and negative polarity

On the other hand, due to the use of connectable portable products and the increased number of video output channels used to receive input from television S-terminal and D-terminal, there is an ongoing trend to use lower power supply voltages of 2.7V or lower.

Moreover, there have been proposals regarding input signal limitation in semiconductor integrated circuit devices including input circuit portions receiving external input signals. JP H5-299959A discloses an integrated circuit including a clipping circuit or a clamping circuit in the input portion in order to prevent input signals from falling below the substrate potential of the semiconductor integrated circuit.

Hereinafter, explanations are provided with regard to conventional semiconductor integrated circuits with built-in negative power supply generation circuits capable of outputting signals with positive and negative polarity. FIG. 5 is a circuit diagram illustrating an example of a conventional semiconductor integrated circuit. In FIG. 5, the semiconductor integrated circuit 16 includes a resistor 1, an output amplifier 2, and a negative power supply generation charge pumping circuit 3. An input signal source 21 is connected to the semiconductor integrated circuit 16 through an input capacitor 22. Furthermore, a flying capacitor 23, a charge capacitor 24, and a load 25 also are connected to the semiconductor integrated circuit 16. The operation of the semiconductor integrated circuit configured in the above-described manner is explained below.

First of all, explanations are provided with regard to negative power supply voltage generation by the negative power supply generation charge pumping circuit 3, the flying capacitor 23, and the charge capacitor 24. Gating waveforms such as the ones shown in FIG. 6 are input to the MOS transistors of the negative power supply generation charge pumping circuit 3. When φ1 is at the L-level, φ2 is at the H-level, and φ3 is at the L-level, the flying capacitor 23 is charged by the VDD-GND voltage. When φ1 is at the H-level, φ2 is at the L-level, and φ3 is at the H-level, the charge stored in the flying capacitor 23 is transferred to the charge capacitor 24. A negative voltage, VSS, is generated by repeating the electric charge transfer. Assuming that the positive power supply voltage is +VDD, ideally, if there is no electric current consumption, the negative voltage VSS of the charge capacitor 24 will be −VDD.

FIG. 7 illustrates the relationship between the direct current flowing to VSS and the VSS voltage value. The negative voltage VSS generated by the negative power supply generation charge pumping circuit 3 is directly proportional to the direct current flowing thereto. Moreover, the change in the VSS relative to the inflow current I varies depending on non-ideal resistance (hereinafter called “negative power supply impedance”, Z=ΔVSS/ΔI) produced by the deviation of the mounting pattern etc. of the flying capacitor 23 and the charge capacitor 24 from the ideal state. The higher the non-ideal resistance value becomes, the more the negative power supply impedance increases, and when the consumed electric current is constant, the absolute value of the VSS decreases.

Next, explanations are provided regarding circuit operation other than negative power supply generation. After DC cutoff by the input capacitor 22, the average value of the input signal (video signal) from input signal source 21 is biased at 0V by a resistor 1 connected between the input terminal and the GND. The output amplifier 2, which uses the VSS of the charge capacitor 24 as a negative power supply, amplifies the signal biased at 0V with the help of the resistor 1, with 0V being a reference level, and drives the load 25. FIG. 8A illustrates an example of the signal waveform obtained at the I/O pin during normal signal input. Here, the output amplifier 2 is capable of outputting a voltage up to VSS−Vsat on the negative side via a collector-to-collector connection, with a gain of 6 dB. Vsat is a saturation voltage between the collector and the emitter of an NPN transistor connected to VSS of the transistors constituting the output amplifier 2. The input signal is zero-biased and the output signal has an amplitude equal to double that of the input signal, with 0V being an average value.

As an example, if Vsat=0.3V, VDD=2.5V, negative power supply impedance is 20Ω, and the current I flowing to the VSS is 10 mA, then VSS−Vsat=−2.5V+20Ω×10 mA+0.3V=−2.0V The output SYNC chip voltage of a White 130% video signal with a 0V average level is approximately −2V, and so, when disregarding any rise in the negative power supply voltage due to the signal current, White 130% is the limit value for obtaining normal output.

Therefore, the SYNC shrinkage of the output signal occurs in the above-described configuration when a high-luminance signal is input and the gain factor times of the SYNC chip voltage in the input signal becomes below VSS−Vsat. FIG. 8B illustrates an example of the waveform obtained at the I/O pin by inputting a signal with a luminance higher than that of FIG. 8A. When the zero-biased input signal is doubled and output by the output amplifier, the saturation of the output NPN transistor of the output amplifier results in the shrinkage of the SYNC portions of the output signal (the hatched portions in FIG. 8B). The SYNC shrinkage phenomenon may cause video signal synchronization on the TV to be impossible.

On the other hand, because of the tendency to use lower power supply voltages and increase consumption current due to operation of multiple output amplifiers as a result of an increase in the number of channels designated for video output, according to trends in recent years, and further because of increased non-ideal resistance values due to mounting pattern inaccuracies, it is impossible in many cases to bring the VSS to a sufficiently low voltage value for the expected video signal. Therefore, suppression of SYNC shrinkage is an important problem in the design of semiconductor integrated circuits outputting video signals.

### SUMMARY OF THE INVENTION

Therefore, with the foregoing in mind, it is an object of the present invention to provide a semiconductor integrated circuit in which SYNC shrinkage in the output amplifier during high luminance signal input is suppressed, so as to be capable of outputting normal signals.

The semiconductor integrated circuit of the present invention has a basic configuration including: a charge pumping circuit for generating a negative power supply voltage; an input portion for biasing an average value of an input signal at 0V, and a video signal output portion that operates with a positive/negative power supply utilizing the charge pumping circuit as a negative power supply to amplify the zero-biased signal, outputting signals of positive/negative polarity. In order to address the above-described problems, the circuit includes a diode clamp circuit connected to the input portion, and a maximum level of a voltage of the input signal on the negative side is clamped to a clamp voltage produced by the diode clamp circuit when the maximum level of the voltage of the input signal on the negative side is lower than the clamp voltage, thereby suppressing shrinkage of the output signal on the negative side.

The video signal amplification method of the present invention includes: biasing an average value of an input signal at 0V; and amplifying the biased signal by using an amplifier operating with a positive/negative power supply utilizing a charge pumping circuit as a negative power supply, thereby outputting an output signal of positive/negative polarity. In order to address the above-described problems, in the step of biasing the average value of the input signal at 0V, a maximum level of a voltage of the input signal on the negative side is clamped to a clamp voltage when the maximum level of the voltage of the input signal on the negative side is lower than the clamp voltage, thereby suppressing shrinkage of the output signal on the negative side.

### BRIEF DESCRIPTION OF THE DRAWINGS

FIG. 1 is a circuit diagram illustrating the configuration of a semiconductor integrated circuit used in a first embodiment of the present invention.

FIG. 2A is a diagram of the signal waveform obtained at the I/O pin during normal signal input in the same semiconductor integrated circuit.

FIG. 2B is a diagram of the signal waveform obtained at the I/O pin during high luminance signal input in the same semiconductor integrated circuit.

FIG. 3 is a circuit diagram illustrating the configuration of a semiconductor integrated circuit used in a second embodiment of the present invention.

FIG. 4 shows voltage waveform diagrams for various points in the same semiconductor integrated circuit.

FIG. 5 is a circuit diagram illustrating the configuration of a conventional semiconductor integrated circuit.

FIG. 6 is a diagram illustrating the clock waveform used for charge pump driving in the same semiconductor integrated circuit.

FIG. 7 is a diagram illustrating the relationship of the value of the negative voltage VSS versus the electric current I flowing to the VSS terminal in the same semiconductor integrated circuit.

FIG. 8A is a diagram of the signal waveform obtained at the I/O pin during normal signal input in the same semiconductor integrated circuit.

FIG. 8B is a diagram of the signal waveform obtained at the I/O pin during high luminance signal input in the same semiconductor integrated circuit.

### DETAILED DESCRIPTION OF THE INVENTION

According to the semiconductor integrated circuit of the present invention, the SYNC shrinkage of the output can be suppressed even when the generated negative power supply voltage is not sufficiently low for the expected input signal.

In the above configuration, the clamp voltage can be set in such a manner that a voltage obtained by multiplying the clamp voltage by a gain factor of the video signal output portion is not less than the lowest voltage that can be output by the video signal output portion as a normal output on the negative side.

Also, the clamp voltage can be set in such a manner that a voltage obtained by multiplying the clamp voltage by a gain factor of the video signal output portion is equal to a voltage that is higher by a predetermined value than the negative power supply voltage.

It is preferable that the circuit further includes a peak detection circuit for detecting the peak value of the negative power supply voltage, wherein in response to the peak value of the negative power supply voltage detected by the peak detection circuit, a set value of the clamp voltage is controlled to be such a value that a voltage obtained by multiplying the clamp voltage by a gain factor of the video signal output portion is not less than the lowest voltage that can be output by the video signal output portion as a normal output on the negative side.

Also, it is preferable that the circuit further includes a peak detection circuit for detecting the peak value of the negative power supply voltage, wherein in response to the peak value of the negative power supply voltage detected by the peak detection circuit, a set value of the clamp voltage is controlled to be such a value that a voltage obtained by multiplying the clamp voltage by a gain factor of the video signal output portion is equal to a voltage that is higher by a predetermined value than the negative power supply voltage.

The diode clamp circuit can include a comparator used to set the clamp voltage and a voltage based on the peak value of the negative power supply voltage detected by the peak detection circuit is supplied as the bias voltage of the comparator.

In this configuration, the circuit can includes a level shift circuit for shifting the level of the detection output of the peak detection circuit higher by the predetermined value and an attenuation circuit attenuating the output of the level shift circuit to 1/(gain of the video signal output portion), wherein the output of the attenuating circuit is supplied as the bias voltage of the comparator.

It preferable that the negative power supply voltage is supplied to the peak detection circuit through a low-pass filter.

Hereinafter, a semiconductor integrated circuit used in an embodiment of the present invention is explained by referring to drawings.

### Embodiment 1

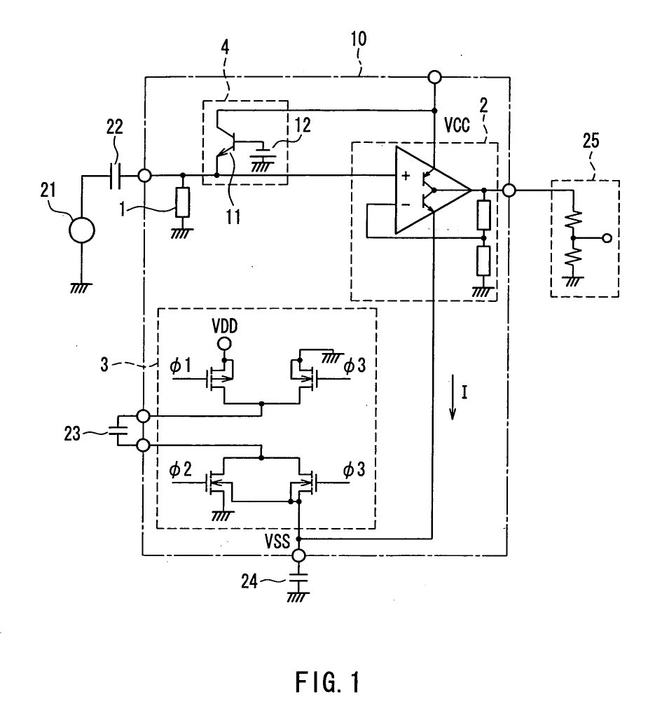

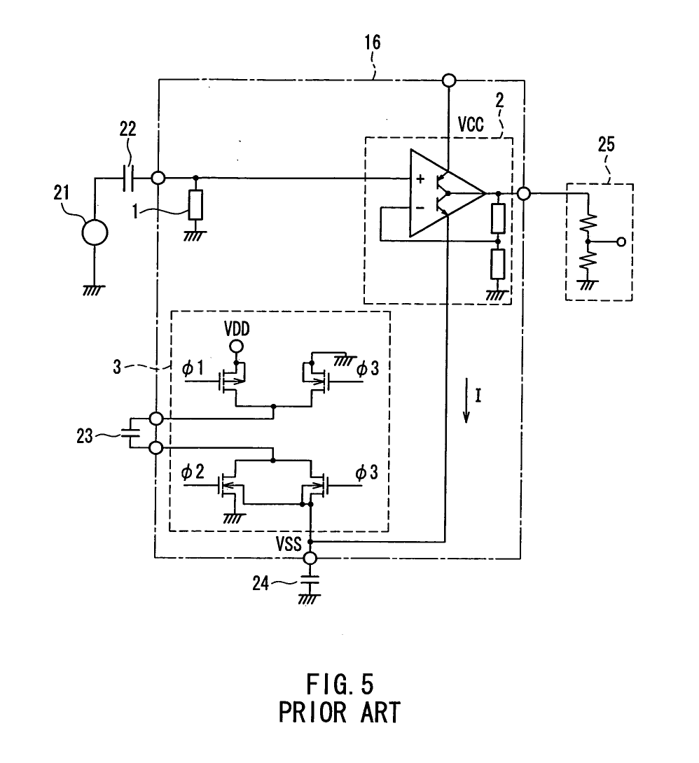

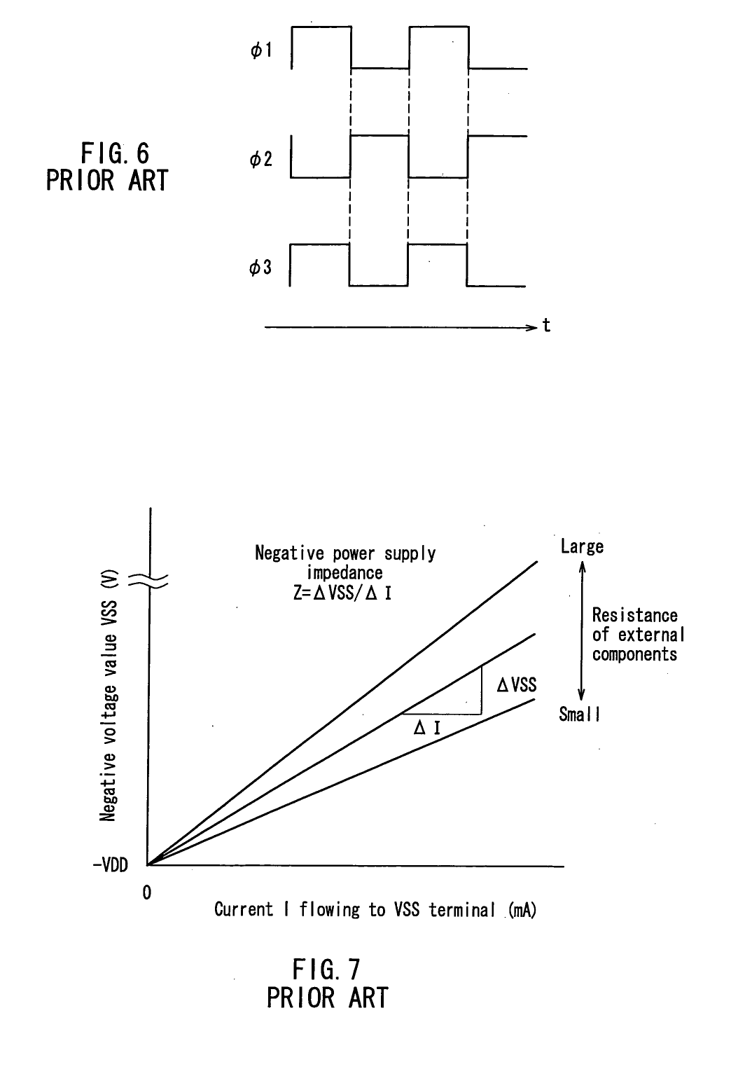

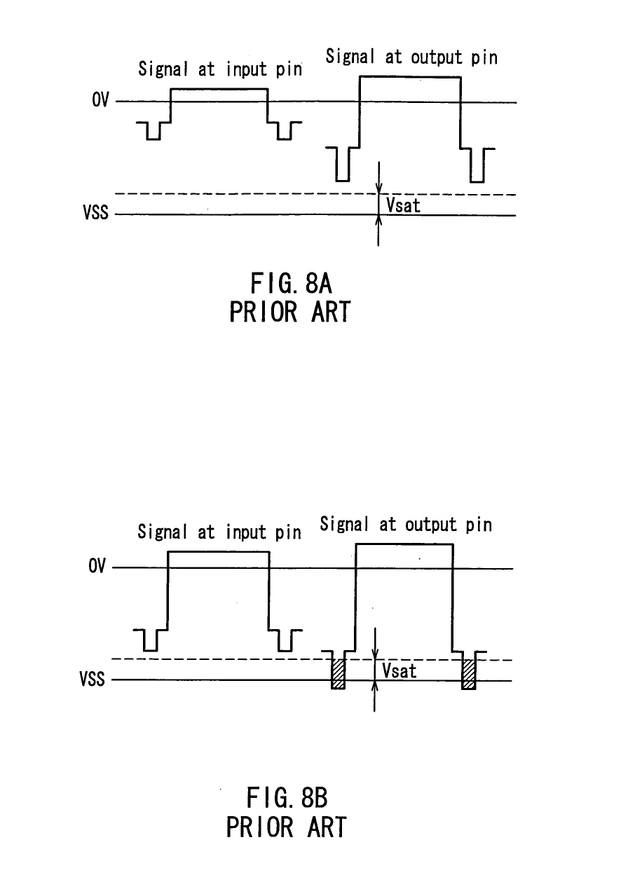

FIG. 1 is a circuit diagram illustrating the configuration of a semiconductor integrated circuit used in a first embodiment of the present invention. Elements identical to the elements of the conventional example shown in FIG. 5 are designated by the same reference numbers in order to simplify the explanation.

In FIG. 1, a semiconductor integrated circuit 10 is composed of a resistor 1, an output amplifier 2, a negative power supply generation charge pumping circuit 3, and a diode clamp circuit 4.

The operation of negative power supply voltage generation, which is based on using the negative power supply generation charge pumping circuit 3, flying capacitor 23, and charge capacitor 24, is the same as in the conventional example shown in FIG. 5. The operation of the input portion base on the resistor 1, as well as the operation of the output portion based on the output amplifier 2, is the same as in the conventional example shown in FIG. 5. The difference of the present embodiment from the conventional example is that a diode clamp circuit 4 is provided in the input portion. The diode clamp circuit 4 is composed of an NPN transistor 11 and a reference voltage source 12 that supplies the base voltage of the NPN transistor 11. A base-emitter voltage determined by the reference voltage source 12 serves as a clamp voltage.

The operation of the semiconductor integrated circuit 10 will be explained with particular emphasis on the operation of the diode clamp circuit 4. In addition, the same situations as in the conventional example shown in FIG. 5 will be used to explain the setting of the voltage values, etc.

After DC cutoff by the input capacitor 22, the average value of the input signal from the input signal source 21 is biased at 0V by the resistor 1 connected between the input terminal and the GND. If the SYNC chip voltage is equal to or higher than the clamp voltage of the diode clamp circuit 4 when the input signal is biased at 0V, the zero-biased input signal is input to the output amplifier 2 “as is”. In the same manner as in the conventional example of FIG. 5, the output amplifier 2 amplifies the zero-biased signal, with 0V being a reference level, and drives the load 25 as a video signal output portion.

If the SYNC chip voltage falls below the clamp voltage when the input signal is biased at 0V the input capacitor 22 is charged by the diode clamp circuit 4 and the SYNC chip voltage at the input pin is clamped to the clamp voltage value. This clamp causes the average voltage of the input signal to be higher than 0V. The output amplifier 2 amplifies the signal clamped by the diode clamp circuit 4, with 0V being a reference level, and drives the load 25.

Taking into account power supply voltage fluctuations and variations in the negative power supply impedance due to mounting pattern inaccuracies, as well as variations in the circuit current flowing to the VSS, the clamp voltage is set in such a manner that a voltage value obtained by multiplying the clamp voltage by the gain factor of the output amplifier 2 becomes not lower than VSS−Vsat.

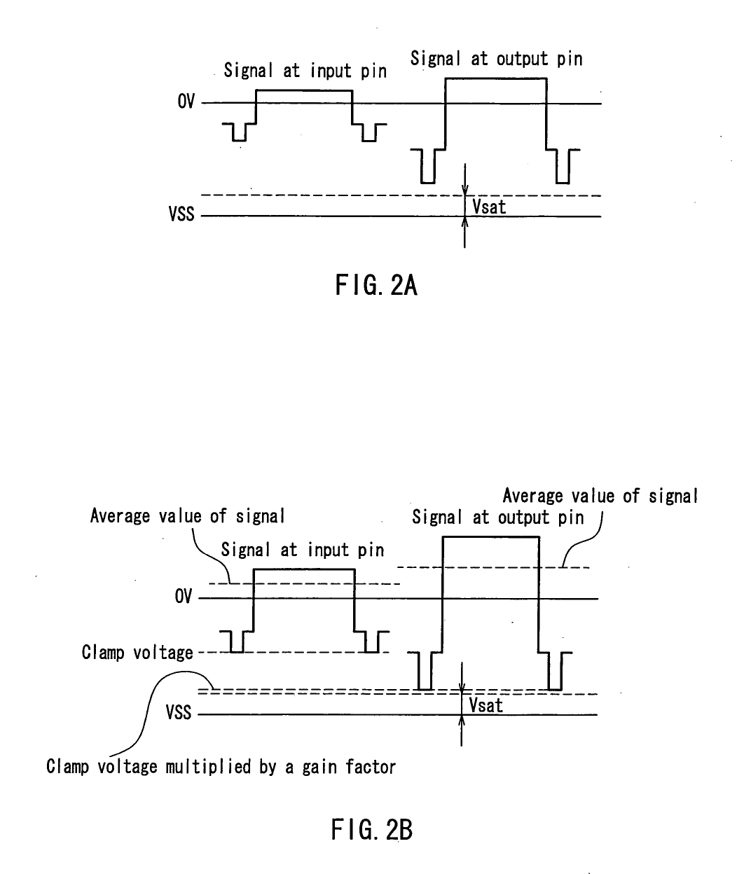

FIG. 2A illustrates an example of the signal waveform obtained at the I/O pin during normal-level signal input. The input signal is biased at 0V and the output signal with 0V being an average level, is output with an amplitude equal to double that of the input signal. FIG. 2B illustrates an example of the waveform obtained at the I/O pin when a high luminance signal is input and the diode clamp circuit 4 is in operation. The input signal is clamped by the diode clamp circuit 4 and the SYNC chip voltage is clamped to the clamp voltage. The output amplifier 2 doubles the clamped input signal, with 0V being a reference level, and outputs it. The output signal is output without SYNC shrinkage because the circuit factor is set so that the gain factor times the clamp voltage becomes not lower than VSS−Vsat.

According to this embodiment, an input signal having a normal luminance level is output in average level of 0V without clamping. On the other hand, an input signal having a luminance level higher than a normal level or an input signal having an input level higher than a normal level is subjected to clamping, so as to suppress SYNC shrinkage. Thus, high luminance signals, which are associated with SYNC shrinkage in the conventional example, can be output without SYNC shrinkage.

In the semiconductor integrated circuit 10 of the present embodiment, basically the clamp voltage is set such that the clamp is not applied up to 2 Vpp at the output pin, i.e. up to signals with a White 100% standard luminance level and applied in the case of luminance levels higher than the standard level and when the input level exceeds the standard level.

### Embodiment 2

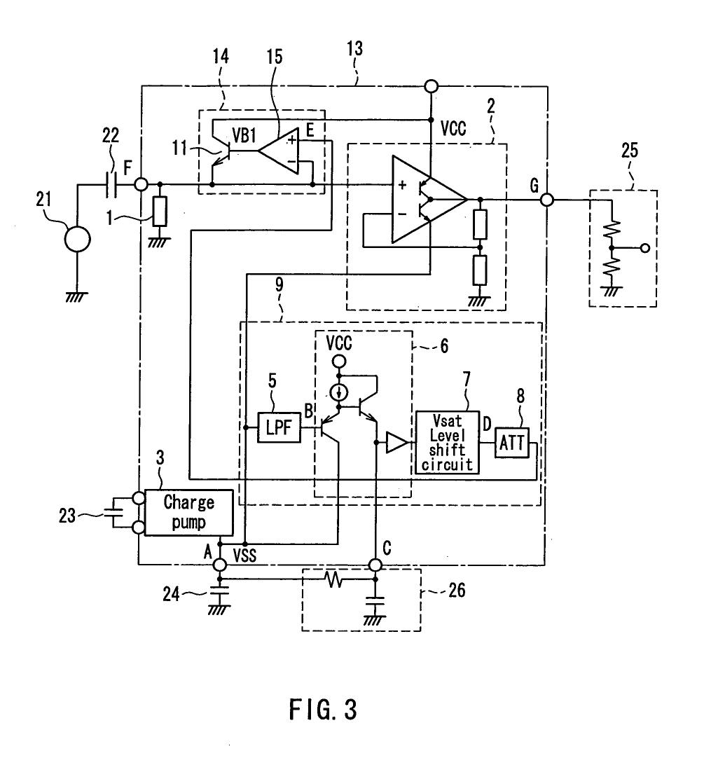

FIG. 3 is a circuit diagram illustrating the configuration of a semiconductor integrated circuit used in a second embodiment of the present invention. In comparison with the first embodiment, this semiconductor integrated circuit 13 has a diode clamp circuit 14 of a modified configuration, and, furthermore, is provided with a clamp voltage setting circuit 9.

Namely, in the configuration of the diode clamp circuit 14, a comparator 15 is provided in place of the reference voltage source 12 of FIG. 1. The clamp voltage setting circuit 9 is composed of a low-pass filter 5, a peak detection circuit 6, a level shift circuit 7, and an attenuation circuit 8. A numeral 26 denotes an outside-attached component for peak detection. A negative power supply voltage value supplied from the negative power supply generation charge pumping circuit 3 is detected by the clamp voltage setting circuit 9 and a bias voltage corresponding to the detection results is supplied to the comparator 15 of the diode clamp circuit 14. Because the clamp voltage of the diode clamp circuit 14 is determined by the bias voltage supplied to the comparator 15, the clamp voltage is changed in response to changes in the negative power supply voltage.

The operation of the semiconductor integrated circuit 13 is explained below.

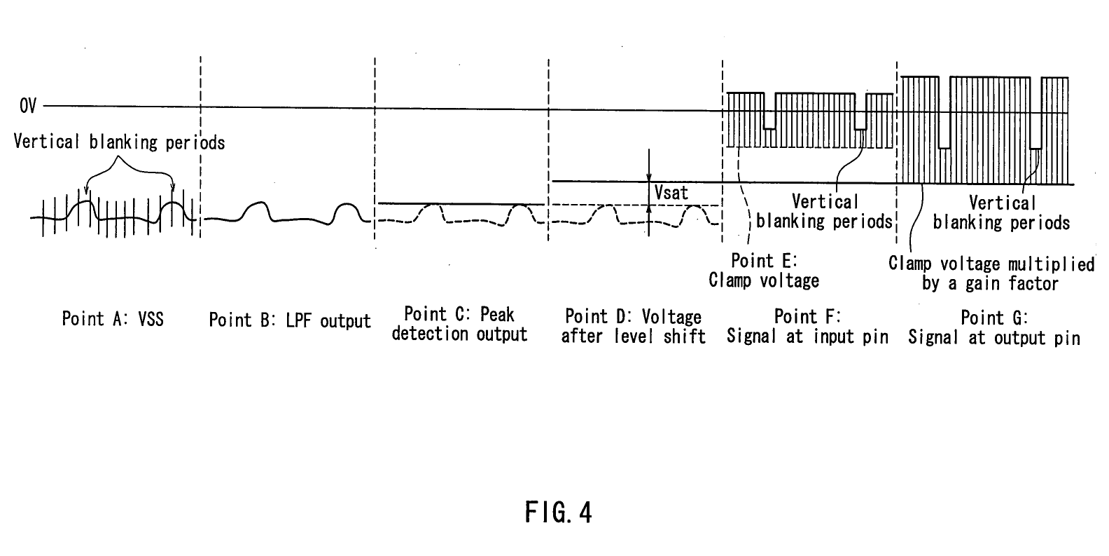

FIG. 4 shows voltage waveforms in respective points of FIG. 3. When a video signal is input from the input signal source 21, the waveform of the negative power supply VSS at point A exhibits elevations in a vertical blanking period. This is due to the fact that since the capacitance value of the charge capacitor 24 is not sufficiently large, the negative power supply impedance at low frequencies is so large that an influence due to change in magnitude in vertical blanking period cannot be ignored. The high frequency noise of the waveform at point A is caused by a manifestation of the clock noise of the charge pump.

The waveform at point B is a waveform obtained by cutting off the high frequency noise of the waveform at point A using the low-pass filter 5. The waveform at point C holds the peak values of the waveform at point B using the peak detection circuit 6, thereby producing a substantial DC value. The voltage waveform at point D is obtained using the level shift circuit 7 to shift the level of the voltage waveform at point C by Vsat. The voltage at point E is obtained by using the attenuation circuit 8 to attenuate the voltage at point D to 1/(gain of the output amplifier 2).

The voltage of point E is input to the comparator 15 of the diode clamp circuit 14 as a biasing voltage. As a result, if the gain factor times the SYNC chip voltage with the input signal being biased at 0V falls below VSS−Vsat, then, as shown by the waveform at point F, the SYNC chip voltage of the input signal is clamped at the voltage of point E. Based on the clamped signal, as the voltage at point G shows, the signal is clamped at VSS−Vsat and output as an output pin signal. In addition, the circuit above operates in such a manner that the input signal is supplied to the output amplifier 2 with biasing voltage at 0V until the gain factor times the SYNC chip voltage with the input signal being biased at zero reaches VSS−Vsat.

In this manner, the present embodiment provides a wide signal dynamic range, where operation at zero bias without SYNC shrinkage is possible by setting the SYNC chip voltage of the output signal obtained when the diode clamp circuit 14 is in operation to VSS−Vsat. In addition, since the clamp voltage is set based on the VSS voltage value, setting the clamp voltage by taking into account power supply voltage fluctuations and variations in the negative power supply impedance due to mounting pattern inaccuracies is no longer necessary, resulting in enhanced general applicability.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A semiconductor integrated circuit comprising: a charge pumping circuit for generating a negative power supply voltage; an input portion for biasing an average value of an input signal at 0V; and a video signal output portion that operates with a positive/negative power supply utilizing the charge pumping circuit as a negative power supply to amplify the zero-biased signal, outputting signals of positive/negative polarity,
wherein a diode clamp circuit is connected to the input portion, and
a maximum level of a voltage of the input signal on the negative side is clamped to a clamp voltage produced by the diode clamp circuit when the maximum level of the voltage of the input signal on the negative side is lower than the clamp voltage, thereby suppressing shrinkage of the output signal on the negative side.

2. The semiconductor integrated circuit according to claim 1, wherein the clamp voltage is set in such a manner that a voltage obtained by multiplying the clamp voltage by a gain factor of the video signal output portion is not less than the lowest voltage that can be output by the video signal output portion as a normal output on the negative side.

3. The semiconductor integrated circuit according to claim 1, wherein the clamp voltage is set in such a manner that a voltage obtained by multiplying the clamp voltage by a gain factor of the video signal output portion is equal to a voltage that is higher by a predetermined value than the negative power supply voltage.

4. The semiconductor integrated circuit according to claim 1, further comprising a peak detection circuit for detecting the peak value of the negative power supply voltage,
wherein in response to the peak value of the negative power supply voltage detected by the peak detection circuit, a set value of the clamp voltage is controlled to be such a value that a voltage obtained by multiplying the clamp voltage by a gain factor of the video signal output portion is not less than the lowest voltage that can be output by the video signal output portion as a normal output on the negative side.

5. The semiconductor integrated circuit according to claim 1, further comprising a peak detection circuit for detecting the peak value of the negative power supply voltage,
wherein in response to the peak value of the negative power supply voltage detected by the peak detection circuit, a set value of the clamp voltage is controlled to be such a value that a voltage obtained by multiplying the clamp voltage by a gain factor of the video signal output portion is equal to a voltage that is higher by a predetermined value than the negative power supply voltage.

6. The semiconductor integrated circuit according to claim 5, wherein the diode clamp circuit includes a comparator used to set the clamp voltage and a voltage based on the peak value of the negative power supply voltage detected by the peak detection circuit is supplied as the bias voltage of the comparator.

7. The semiconductor integrated circuit according to claim 6, which includes a level shift circuit for shifting the level of the detection output of the peak detection circuit higher by the predetermined value and an attenuation circuit attenuating the output of the level shift circuit to 1/(gain of the video signal output portion), wherein the output of the attenuating circuit is supplied as the bias voltage of the comparator.

8. The semiconductor integrated circuit according to claim 4, wherein the negative power supply voltage is supplied to the peak detection circuit through a low-pass filter.

9. A video signal amplification method comprising:
biasing an average value of an input signal at 0V; and
amplifying the biased signal by using an amplifier operating with a positive/negative power supply utilizing a charge pumping circuit as a negative power supply, thereby outputting an output signal of positive/negative polarity,
wherein in the step of biasing the average value of the input signal at 0V a maximum level of a voltage of the input signal on the negative side is clamped to a clamp voltage when the maximum level of the voltage of the input signal on the negative side is lower than the clamp voltage, thereby suppressing shrinkage of the output signal on the negative side.
